(19) United States
(12) Patent Application Publication
(10) Pub. No.: US 2006/0275670 A1
(43) Pub. Date: Dec. 7, 2006

(54) Post-curing of holographic media

(75) Inventors: Brian S. Riley, Firestone, CO (US); Ken E. Anderson, Boulder, CO (US); Larry Fabiny, Boulder, CO (US); Ian R. Redmond, Boulder, CO (US); Curtis A. Shuman, Colorado Springs, CO (US); Bradley J. Sissom, Boulder, CO (US); Kevin R. Curtis, Longmont, CO (US); Aaron Wegner, Longmont, CO (US); Michael C. Cole, Longmont, CO (US)

Correspondence Address: JAGTIANI + GUTTAG, 10363-A DEMOCRACY LANE, FAIRFAX, VA, 22030, US

(73) Assignee: InPhase Technologies, Inc., Longmont, CO (US)

(21) Appl. No.: 11/440,367

(22) Filed: May 25, 2006

Related U.S. Application Data
(60) Provisional application No. 60/684,531, filed on May 26, 2005.

(51) Int. Cl. G03H 1/04

(52) U.S. Cl. 430/1

(57) ABSTRACT

The present invention relates to embodiments of a process for subjecting a holographic storage medium to illuminative treatment to: (1) enhance or optimize recording of holographic data; (2) enhance or optimize reading of recorded holographic data; and/or (3) erase recorded holographic data. The present invention also relates to embodiments of a system comprising: (a) an illuminative treatment beam; (b) means for reducing the coherence of the beam and (c) means for transmitting the reduced coherence beam to cause illuminative treatment of: (1) an unrecorded portion of a holographic storage medium to provide pre-cured portions having increased ability to stably record holographic data; (2) a recorded portion of a holographic storage medium to provide a post-cured portion having reduced residual sensitivity; and/or (3) a recorded portion of a holographic storage medium having holographic data to provide an erased portion wherein at least some of the recorded holographic data is erased.

### CROSS-REFERENCE TO RELATED APPLICATIONS

This application makes reference to and claims the benefit of the following co-pending U.S. Provisional Patent Application No. 60/684,531 filed May 26, 2005. The entire disclosure and contents of the foregoing Provisional Application is hereby incorporated by reference. This application also makes reference to the following co-pending U.S. Patent Applications. The first application is U.S. App. No. [INPH-0007-UT1], entitled “Illuminative Treatment of Holographic Media,” filed May 25, 2006. The second application is U.S. App. No. [INPH-0007-UT2], entitled “Methods and Systems for Laser Mode Stabilization,” filed May 25, 2006. The third application is U.S. App. No. [INPH-0007-UT3], entitled “Phase Conjugate Reconstruction of Hologram,” filed May 25, 2006. The fourth application is U.S. App. No. [INPH-0007-UT4], entitled “Improved Operational Mode Performance of a Holographic Memory System,” filed May 25, 2006. The fifth application is U.S. App. No. [INPH-0007-UT5], entitled “Holographic Drive Head and Component Alignment,” filed May 25, 2006. The sixth application is U.S. App. No. [INPH-0007-UT6], entitled “Optical Delay Line in Holographic Drive,” filed May 25, 2006. The seventh application is U.S. App. No. [INPH-0007-UT7], entitled “Controlling the Transmission Amplitude Profile of a Coherent Light Beam in a Holographic Memory System,” filed May 25, 2006. The eighth application is U.S. App. No. [INPH-0007-UT8], entitled “Sensing Absolute Position of an Encoded Object,” filed May 25, 2006. The ninth application is U.S. App. No. [INPH-0007-UT9], entitled “Sensing Potential Problems in a Holographic Memory System,” filed May 25, 2006. The tenth application is U.S. App. No. [INPH-0007-UT11], entitled “Post-Curing of Holographic Media,” filed May 25, 2006. The eleventh application is U.S. App. No. [INPH-0007-UT12], entitled “Erasing Holographic Media,” filed May 25, 2006. The twelfth application is U.S. App. No. [INPH-0007-UT13], entitled “Laser Mode Stabilization Using an Etalon,” filed May 25, 2006. The thirteenth application is U.S. App. No. [INPH-0007-UT15], entitled “Holographic Drive Head Alignments,” filed May 25, 2006. The fourteenth application is U.S. App. No. [INPH-0007-UT16], entitled “Replacement and Alignment of Laser,” filed May 25, 2006. The entire disclosure and contents of the foregoing U.S. Patent Applications are hereby incorporated by reference.

### BACKGROUND

1. Field of the Invention

The present invention broadly relates to illuminative treatment of a holographic storage medium to: (1) pre-cure the medium so that the medium has increased ability to stably record holographic data; (2) post-cure the medium to remove or minimize residual media sensitivity; and/or (3) erase previously recorded holographic data in the medium. The present invention further broadly relates to systems for carrying out such illuminative treatments.

2. Related Art

Developers of information storage devices and methods continue to seek increased storage capacity. As part of this development, holographic memory systems have been suggested as alternatives to conventional memory devices. Holographic memory systems may be designed to record data as one bit of information (i.e., bit-wise data storage). See McLeod et al. “Micro-Holographic Multi-Layer Optical Disk Data Storage,” International Symposium on Optical Memory and Optical Data Storage (July 2005). Holographic memory systems may also be designed to record an array of data that may be a 1-dimensional linear array (i.e., a 1×N array, where N is the number linear data bits), or a 2-dimension array commonly referred to as a “page-wise” memory system. Page-wise memory systems may involve the storage and readout of an entire two-dimensional representation, e.g., a page of data. Typically, recording light passes through a two-dimensional array of low and high transparency areas representing data, and the system stores, in three dimensions, the pages of data holographically as patterns of varying refractive index imprinted into a storage medium. See Psaltis et al., “Holographic Memories,” Scientific American, November 1995, where holographic systems are discussed generally, including page-wise memory systems.

In a holographic data storage system, information is recorded by making changes to the physical (e.g., optical) and chemical characteristics of the holographic storage medium. These changes in the holographic medium take place in response to the local intensity of the recording light. That intensity is modulated by the interference between a data-bearing beam (the data beam) and a non-data-bearing beam (the reference beam). The pattern created by the interference of the data beam and the reference beam forms a hologram which may then be recorded in the holographic medium. If the data-bearing beam is encoded by passing the data beam through, for example, a spatial light modulator (SLM), the hologram(s) may be recorded in the holographic medium as an array of light and dark squares or pixels. The holographic medium or at least the recorded portion thereof with these arrays of light and dark pixels may be subsequently illuminated with a reference beam (sometimes referred to as a reconstruction beam) of the same or similar wavelength, phase, etc., so that the recorded data may be read.

One type of holographic storage medium used recently for such holographic data storage systems are photosensitive polymer films. Photosensitive polymer films are considered attractive recording media candidates for high density holographic data storage. These films have a relatively low cost, are easily processed and can be designed to have large index contrasts with high photosensitivity. These films may also be fabricated with the dynamic range, media thickness, optical quality and dimensional stability required for high density applications. See, e.g., L. Dhar et al., “Recording Media That Exhibit High Dynamic Range for Holographic Storage,” Optics Letters, 24, (1999): pp. 487 et. seq; Smothers et al., “Photopolymers for Holography,” SPIE OE/Laser Conference, (Los Angeles, Calif., 1990), pp.: 1212-03.

The holographic storage media described in Smothers et al., supra contain a photoimageable system containing a liquid monomer material (the photoactive monomer) and a photoinitiator (which promotes the polymerization of the monomer upon exposure to light), where the photoimageable system is in an organic polymer host matrix that is substantially inert to the exposure light. During writing (recording) of data into the holographic medium, the monomer polymerizes in the exposed regions. Due to the lowering of the monomer concentration caused by the polymerization, monomer from the dark, unexposed regions of the material diffuses to the exposed regions. The polymerization and resulting diffusion create a refractive index change, thus forming the hologram representing the data.

The characteristics and capabilities of the holographic storage medium may depend upon or be affected by a number of factors, and especially the nature, properties, composition, etc., of the holographic medium. For example, the optical and chemical characteristics of a holographic medium may affect how the medium absorbs different wavelengths of light, the speed with which a particular wavelength of light is absorbed, how well or uniformly the medium records the holograms with respect to the particular wavelength of light, etc. In addition, the recording characteristics of the holographic medium may change as the various chemical components present in the medium are used up or formed, as the medium ages over time, etc. All of these factors may affect and may make less optimal the characteristics and capabilities of the holographic medium to record and/or read data.

Optimization of the characteristics and capabilities of the holographic medium may also depend at what point the holographic storage medium is in the data storage cycle. In other words, what are optimal characteristics and capabilities of the holographic medium for recording holographic data may not be optimal or desirable for a holographic medium that is ready to be read. For example, at the point that holographic data is being recorded by all or a portion of the holographic medium, the characteristics and capabilities of the medium should be optimized to enhance the recording of the holographic data, such as the speed at which the data is recorded, the clarity at which the data is recorded, etc. It may also be desirable to provide that each portion of holographic data is advantageously recorded using the same or similar time increments while achieving the same or similar diffraction efficiencies to enable simplification of recording data to and reading data from the holographic medium.

By contrast, after a selected portion or all of the holographic data is recorded by the holographic medium, it may be desirable to change or alter the characteristics and capabilities of that portion of the medium that contains recorded data. For example, if the characteristics and capabilities of the medium, or portion thereof, that contains recorded holographic data are not altered or changed appropriately, the recorded data may be degraded in quality and especially readability, may become obscured through the creation of noise holograms that may impair the ability to decode the reconstructed data page, etc. It may also be desirable to remove or erase all or a selected portion or portions of the recorded data from the holographic medium so that new holographic data may be recorded on those erased portions of the medium.

Accordingly, what may be needed is a way to alter or change the characteristics and capabilities of the holographic medium before or after the recording of holographic data so that: (1) the medium's characteristics and capabilities may be enhanced or optimized at that point in the data storage cycle; (2) each portion of the holographic data may be recorded by the medium in an improved fashion (e.g., more efficiently, more stably, etc.); (3) degrading of the quality and especially the readability of the recorded holographic data, as well as obscuring of the recorded data by, for example, noise holograms, may be minimized or avoided; and (4) all or selected portions of the recorded holographic data may be erased so that new holographic data may be recorded on those erased portions of the medium.

### SUMMARY

According to a first broad aspect of the present invention, there is provided a process comprising the following steps of:
(a) providing a holographic storage medium having an uncured portion; and
(b) subjecting the uncured portion to illuminative pre-curing with a curing beam having reduced coherence and a substantially uniform intensity distribution to provide a pre-cured portion having increased ability to stably record holographic data.

According to a second broad aspect of the present invention, there is provided a system comprising:
a curing beam;
means for reducing coherence of the curing beam to provide a curing beam having reduced coherence; and
means for transmitting the reduced coherence curing beam with a substantially uniform intensity distribution to cause illuminative curing of an uncured portion of a holographic storage medium to provide pre-cured portions having increased ability to stably record holographic data.

According to a third broad aspect of the present invention, there is provided a process comprising the following steps of:
(1) providing a holographic storage medium having a recorded portion; and
(2) subjecting the recorded portion to illuminative post-curing with a curing beam having reduced coherence and a substantially uniform intensity distribution to provide a post-cured portion having reduced residual sensitivity.

According to a fourth broad aspect of the present invention, there is provided a system comprising:
a curing beam;
means for reducing coherence of the curing beam to provide a curing beam having reduced coherence and
means for transmitting the reduced coherence curing beam with a substantially uniform intensity distribution to cause illuminative post-curing of a recorded portion of a holographic storage medium to provide a post-cured portion having reduced residual sensitivity.

According to a fifth broad aspect of the present invention, there is provided a process comprising the following steps of:
(a) providing a holographic storage medium having an uncured portion;
(b) subjecting the uncured portion to illuminative pre-curing with a curing beam having reduced coherence and a substantially uniform intensity distribution to provide a pre-cured portion having increased ability to stably record holographic data;
(c) recording holographic data in the pre-cured portion to provide a recorded portion having holographic data; and
(d) subjecting the recorded portion to illuminative post-curing with a curing beam having reduced coherence and a substantially uniform intensity distribution to provide a post-cured recorded portion having reduced residual sensitivity.

According to a sixth broad aspect of the present invention, there is provided a system comprising:
a curing beam;
means for reducing coherence of the curing beam to provide a curing beam having reduced coherence; and
means for transmitting the reduced coherence curing beam with a substantially uniform intensity distribution to cause, in sequence: (1) illuminative pre-curing of an uncured unrecorded portion of a holographic storage medium to provide a pre-cured portion having increased ability to stably record holographic data; and (2) illuminative post-curing of the pre-cured portion having recorded holographic data to provide a post-cured recorded portion having reduced residual sensitivity.

According to a seventh broad aspect of the present invention, there is provided a process comprising the following steps of:
(a) providing a holographic storage medium having a recorded portion with holographic data; and
(b) subjecting the recorded portion to illuminative erasing with an erasing beam having a substantially uniform intensity distribution to provide an erased portion wherein at least some of the recorded holographic data is erased, and wherein the erasing beam has a wavelength different from the wavelength of the recording light used to provide the recorded holographic data.

According to an eighth broad aspect of the present invention, there is provided a system comprising:
an erasing beam source for generating an erasing beam having a wavelength different from a wavelength of recording light generated by a recording light source; and
means for transmitting the erasing beam with a substantially uniform intensity distribution to cause illuminative erasing of a portion of a holographic storage medium having recorded holographic data to provide an erased portion wherein at least some of the recorded holographic data is erased;
wherein the erasing beam source is different from the recording light source.

According to a ninth broad aspect of the present invention, there is provided a system comprising:
a single means for generating an erasing beam having a first wavelength, and for generating recording light having a second wavelength; and
means for transmitting the erasing beam with a substantially uniform intensity distribution to cause illuminative erasing of a portion of a holographic storage medium having recorded holographic data to provide an erased portion wherein at least some of the recorded holographic data is erased;
wherein the first wavelength is different from the second wavelength.

According to a tenth broad aspect of the present invention, there is provided a process comprising the following steps of:
(a) providing a holographic storage medium having a recorded portion;
(b) subjecting the recorded portion to illuminative post-curing with a curing beam having reduced coherence and a substantially uniform intensity distribution to provide a post-cured portion having reduced residual sensitivity; and
(c) subjecting the post-cured portion to illuminative erasing with an erasing beam having a substantially uniform intensity distribution to provide an erased portion wherein at least some of the recorded holographic data is erased.

According to an eleventh broad aspect of the present invention, there is provided a system comprising:
a curing beam having reduced coherence;
means for transmitting the reduced coherence curing beam with a substantially uniform intensity distribution to cause illuminative post-curing of a portion of a holographic storage medium having recorded holographic data to provide a post-cured recorded portion having reduced residual sensitivity;
an erasing beam; and
means for transmitting the erasing beam with a substantially uniform intensity distribution to cause illuminative erasing of the post-cured portion to provide an erased portion wherein at least some of the recorded holographic data is erased.

### BRIEF DESCRIPTION OF THE DRAWINGS

The invention will be described in conjunction with the accompanying drawings, in which:

FIG. 1 is a schematic block diagram of an exemplary holographic data storage system which embodiments of the illuminative treatment process and system of the present invention may be used with;

FIG. 2A is an architectural block diagram of the components of a holographic data storage system illustrating the optical paths used during a write or record operation;

FIG. 2B is an architectural block diagram of the components of a holographic data storage system illustrating the optical paths used during a read or reconstruct operation;

FIG. 3 is an illustrative media response curve showing relative exposure time of the holographic medium to recording light to obtain holograms of equal or nearly equal, as a function of hologram number over the entire dynamic range of the medium;

FIG. 4 shows a selected enlarged portion of an illustrative media response curve, which is compared with an illustrative data transfer rate curve, as a function of the maximum number of holograms recorded in one location of the holographic storage medium; and

FIG. 5 is an architectural block diagram of the components of in an embodiment of an illuminative treatment system according to the present invention for illuminative treatment of a holographic storage medium.

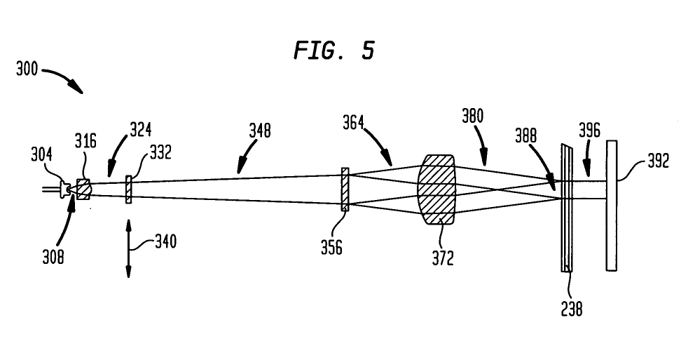

### DETAILED DESCRIPTION

It is advantageous to define several terms before describing the invention. It should be appreciated that the following definitions are used throughout this application.

Definitions

Where the definition of terms departs from the commonly used meaning of the term, applicants intend to utilize the definitions provided below, unless specifically indicated.

For the purposes of the present invention, the term “light source” refers to any source of electromagnetic radiation of any wavelength. The light source of the present invention may be from one or more lasers, one or more light emitting diodes (LEDs), etc.

For the purposes of the present invention, the term “photoinitiating light source” refers to a light source that activates a photoinitiator, a photoactive polymerizable material, a photoreactive material or any combination thereof. Photoiniating light sources may include recording light, etc.

For the purposes of the present invention, the term “photoreactive material” refers to a material that can form a holographic grating with recording light, but is not necessarily from photopolymerization, and has the property of being erasable (reversible grating formation) upon exposure to a light source of a wavelength different from the recording wavelength.

For the purposes of the present invention, the term “photoactive luminescent materials” refers to materials which emit light depending upon their environment. For instance, many of the photoinitiators may have an inherent fluorescence, phosphorescence, or both. The photoproducts of the photoinitiators often have a different fluorescence or phosphorescence characteristic, as well as photoreactive components in that luminescence characteristics may change depending upon the light exposure history. A photoactive luminescent material which is not a photoinitiator, the by products of the photoinitiator, or a photoreactive material may be used. For example, some monomers may fluoresce in the unpolymerized state but do not fluoresce in the polymerized state. Also, some luminescent materials may not fluoresce in the presence of oxygen (or vice versa). Such changes in luminescence may enable the monitoring of the status of the holographic medium at any given time. Such monitoring may be accomplished by detectors (e.g., a camera) and by the use of optical filters which select for specific wavelengths.

For the purposes of the present invention, the term “spatial light intensity” refers to a light intensity distribution or pattern of varying light intensity within a given volume of space.

For the purposes of the present invention, the terms “holographic grating,” “holograph” or “hologram” (collectively and interchangeably referred to hereafter as “hologram”) are used in the conventional sense of referring to an interference pattern formed when a signal beam and a reference beam interfere with each other. In cases wherein data is recorded page-wise, the signal beam may be encoded with a data modulator, e.g., a spatial light modulator, to provide a data beam.

For the purposes of the present invention, the term “holographic recording” refers to a hologram after it is recorded in the holographic medium. The holographic recording may provide bit-wise storage (i.e., recording of one bit of data), may provide storage of a 1-dimensional linear array of data (i.e., a 1×N array, where N is the number linear data bits), or may provide 2-dimensional storage of a page of data.

For the purposes of the present invention, the term “holographic storage medium” refers to a component, material, etc., that is capable of recording and storing, in three dimensions (i.e., the X, Y and Z dimensions), one or more holograms (e.g., bit-wise, linear array-wise or page-wise) as one or more patterns of varying refractive index imprinted into the medium.

For the purposes of the present invention, the terms “dynamic range” or “M#” relate to an intrinsic property of a holographic medium and refer to the total response of that medium when portioned among the one or more holograms recorded in a common volume and related to the index change and thickness of that medium. See Shelby, “Media Requirements for Digital Holographic Data Storage,” Holographic Data Storage, Section 1.3 (Coufal, Psaltis, Sincerbox Eds. 2003).

For the purposes of the present invention, the term “diffraction efficiency” of a recorded hologram refers to the fraction of light refracted into a reconstructed object or reference beam by the recorded hologram when illuminated with a beam of light at the same or similar position, angle, wavelength, etc., to the object or reference beam used to record that hologram.

For the purposes of the present invention, the term “percentage of dynamic range used” refers to how much of the dynamic range of a holographic medium has been used, relative to the total dynamic range capacity of the medium. For example, assuming all multiplexed holograms overlapping in a given volume have an equal diffraction efficiency, M#, the diffraction efficiency (DE) may be related by the following equation: DE=(M#/n)², wherein n is the number of holograms multiplexed in that volume.

For the purposes of the present invention, the term “holographic data” refers to data stored in the holographic medium as one or more holograms.

For the purposes of the present invention, the term “data page” or “page” refers to the conventional meaning of data page as used with respect to holography. For example, a data page may be a page of data, one or more pictures, etc., to be recorded or recorded in a holographic medium.

For the purposes of the present invention, the term “recording light” refers to a light source used to record information, data, etc., into a holographic medium.

For the purposes of the present invention, the term “non-recording light” refers to a light source that does not or is not intended to record information, data, etc., into a holographic medium. Non-recording light may include non-information bearing light.

For the purposes of the present invention, the term “illuminative treatment beam” refers any non-recording light beam used to carry out illuminative curing or illuminative erasing.

For the purposes of the present invention, the term “curing beam” refers to a non-recording light beam used to carry out illuminative curing of a holographic medium.

For the purposes of the present invention, the term “erasing beam” refers to a non-recording light beam used to carry out illuminative erasing of a holographic medium.

For the purposes of the present invention, the terms “uniform intensity light” and “constant intensity light” refer interchangeably to a light source that is spatially uniform (e.g., is non-Gaussian) in intensity.

For the purposes of the present invention, the term “non-uniform intensity light” refers to a light source that is not spatially uniform (e.g., is Gaussian) in intensity.

For the purposes of the present invention, the term “substantially uniform intensity distribution” (also known as “substantially uniform illumination profile”) refers to an area or volume wherein the intensity of light is substantially the same everywhere in that area or volume, typically with less than about 20% variation in intensity.

For the purposes of the present invention, the term “recording data” refers to writing or storing holographic data in a holographic medium.

For the purposes of the present invention, the term “reading data” refers to retrieving, recovering, or reconstructing holographic data stored in a holographic medium.

For the purposes of the present invention, the term “illuminative treatment” refers to any treatment of a holographic medium with a non-recording light beam for the purpose of altering, changing, etc., the properties, physical characteristics, ability, capability, etc., of a portion or all of the dynamic range of the medium. Illuminative treatment includes illuminative curing and/or illuminative erasing.

For the purposes of the present invention, “illuminative curing” refers to illuminative treatment with a curing beam that causes pre-curing or post-curing of all or a portion of a holographic medium.

For the purposes of the present invention, the term “pre-curing” refers to illuminative curing of a portion or all of an uncured holographic medium with a curing beam to increase the ability of the pre-cured portion of the medium to stably record holograms.

For the purposes of the present invention, the term “pre-cured medium” refers to a holographic medium (or portion thereof) that has been subjected to pre-curing with a curing beam.

For the purposes of the present invention, the term “contiguous or nearly contiguous tiled geometry” refers to discrete locations in a holographic medium where the holographic medium has been subjected to illuminative treatment, where such locations may or may not overlap in whole or in part and which may leave small portions of the holographic medium unexposed to illuminative treatment. Typically, a holographic medium, or portion thereof, subjected to illuminative treatment with a contiguous or nearly contiguous tiled geometry has more than about 90% of the portion exposed to illuminative treatment.

For the purposes of the present invention, the term “uncured holographic medium” refers to a holographic medium (or portion thereof) that has not been subjected to treatment with a curing beam, e.g., pre-curing.

For the purposes of the present invention, the term “increase the ability of the holographic medium to stably record holograms” refers to the ability to not only record holograms, but also to record holograms without the holograms degrading, disappearing, dissipating, etc., over time, i.e., form stable holograms. Increasing the ability to record stable holograms may also include imparting to the pre-cured portion of the holographic medium a relatively advantageous media response behavior in recording holograms.

For the purposes of the present invention, the term “media response” refers to the relative ability of the holographic medium to record holograms having equal or nearly equal diffraction efficiencies in the same volume of the medium as a function of exposure time to recording light.

For the purposes of the present invention, the term “media response curve” refers to a graphical plot of the media response as a function of required exposure time to recording light versus the number of holograms recorded.

For the purposes of the present invention, the term “disadvantageous media response behavior” refers to a media response where the holographic medium is unable to record stable holograms, or where the holographic medium is able to record stable holograms having equal or nearly equal diffraction efficiencies only by using greatly increased exposure times (representing slower data transfer rates for the holographic storage system) or by using exposure times which vary significantly (e.g., by a factor of greater than about 4 depending upon the desired data transfer characteristics of the holographic storage system) relative to exposure times of the majority of holograms recorded in the same or similar sequence in the same volume of the medium.

For the purposes of the present invention, the term “disadvantageous response region” refers to that region or regions of the media response curve where a holographic medium exhibits a disadvantageous media response behavior.

For the purposes of the present invention, the term “relatively advantageous media response behavior” refers to a media response where the holographic medium is able to record stable holograms having equal or nearly equal diffraction efficiencies using relatively modest or fast exposure times (e.g., providing relatively reasonable or fast data transfer rates for the holographic storage system) which have relatively low variability (e.g., vary by a factor of about 4 or less) relative to exposure times of the majority of holograms recorded in the same or similar sequence in the same volume of the medium.

For the purposes of the present invention, the term “relatively advantageous response region” refers to that region of the media response curve where a holographic medium exhibits a relatively advantageous media response behavior.

For the purposes of the present invention, the term “post-curing” refers to illuminative curing of a holographic medium with a curing beam that minimizes, removes, reduces, diminishes, etc., some or all of the residual sensitivity from a portion or all of the dynamic range of the medium to subsequent exposure to a light source, e.g., a recording or photoinitiating source. This residual sensitivity may cause accidental, inadvertent, unintentional, etc., holograms (e.g., noise holograms) to form due to, for example, self-interference of coherent light beams used for recording data, that may obscure holographic data, impair the ability to decode reconstructed holographic data, etc. and is thus undesired.

For the purposes of the present invention, the term “post-cured medium” refers to a holographic medium that has been subjected to post-curing.

For the purposes of the present invention, the term “illuminative erasing” refers to illuminative treatment with an erasing beam that causes partial or complete removal of recorded holographic data from all or a portion of the medium

For the purposes of the present invention, the term “erased medium” refers to a holographic medium that has been subjected to illuminative erasing.

For the purposes of the present invention, the term “transmission” refers to transmission of a light beam from one component, element, article, etc., to another component, element, article, etc.

For the purposes of the present invention, the term “coherence” refers to one or more light beams, which, when combined, form a static distribution of constructive and destructive interference fringes. Coherence may include spatial coherence or temporal coherence.

For the purposes of the present invention, the term “coherence reduction” refers to where the coherence properties of a light beam have been reduced, minimized, lowered, moderated, diminished, eliminated, etc., to reduce, minimize, lower, moderate, diminish, eliminate, etc., interference fringes or where these effects are mitigated, such as, for example, translating interference fringes across a surface or volume so that the cumulative energy input over some period of time is approximately uniform.

For the purposes of the present invention, the term “diffuser” refers to a device which has the ability to scatter light in a controlled manner, fashion, etc., so as to evenly or more evenly distribute the light and thus reduce the spatial coherence of an illuminative treatment beam. A diffuser may additionally reduce temporal coherence effects of the illuminative treatment beam by having motion imparted to the diffuser.

For the purposes of the present invention, the term “motion” with reference to the motion imparted to the diffuser may refer to linear motion (e.g., one dimensional linear translation), rotational motion (e.g., in an arc, circle, oval, etc.), oscillating (e.g., back and forth linear or rotational motion), etc., that may be continuous, may include pauses, may be at regular or periodic intervals, etc., or any combination thereof. The amount of motion imparted may depend on the particular diffuser used, the coherence reduction effects to be created by the diffuser, etc.

For the purposes of the present invention, the term “shaping” refers to forming or otherwise shaping the illuminative treatment beam so that only a selected portion, area, etc., of the holographic medium having, for example, a predetermined geometry, is subjected to illuminative treatment.

For the purposes of the present invention, the term “lenslet” refers to an optical device comprising a plurality of shaped lens arrayed, organized, arranged, structured, ordered, etc., to operate as a unitary optical device. Each of the individual lenses of the lenslet may be designed to have a specific size, shape, curvature, etc., to achieve the combined effect or effects desired for the lenslet. The individual lenses of the lenslet may be stamped or otherwise formed from a single optical element.

For the purposes of the present invention, the term “multi-pass curing” refers to where the same curing beam, or portion thereof, passes through a holographic medium two or more times during illuminative curing, e.g., pre-curing or post-curing.

For the purposes of the present invention, “multi-pass erasing” refers to where the same erasing beam, or portion thereof, passes through a holographic medium two or more times during illuminative erasing.

For the purposes of the present invention, the term “substantially linear translation” refers to movement of the medium substantially along a linear axis.

For the purposes of the present invention, the term “continuous, unidirectional rotation” with regard to movement of the holographic medium refers to smooth rotation of the medium in one direction about a rotational axis perpendicular to the plane of the medium without halting rotation periodically or intermittently.

For the purposes of the present invention, the term “substrate” refers to components, materials, etc., such as, for example, glass plates or plastic plates, which are associated with the holographic medium, and which often provide a supporting structure for the holographic medium. Substrates may also optionally provide other beneficial properties for the article, e.g., rendering the holographic medium optically flat, etc.

For the purposes of the present invention, the term “support matrix” refers to a material, medium, substance, etc., of a holographic medium in which a polymerizable component may be dissolved, dispersed, embedded, enclosed, etc. The support matrix may be a low T_{g} polymer, may be organic, inorganic, or a mixture of the two, and may also be either a thermoset or thermoplastic.

For the purposes of the present invention, the term “oligomer” refers to a polymer having approximately 30 repeat units or less or any large molecule able to diffuse at least about 100 nm in approximately 2 minutes at room temperature when dissolved in a holographic medium of the present invention. Such oligomers may contain one or more polymerizable groups whereby the polymerizable groups may be the same or different from other possible monomers in the polymerizable component. Furthermore, when more than one polymerizable group is present on the oligomer, they may be the same or different. Additionally, oligomers may be dendritic. Oligomers are considered herein to be photoactive monomers, although they are sometimes referred to as photoactive oligomer(s).

For the purposes of the present invention, the term “photopolymerization” refers to any polymerization reaction caused by exposure to a photoinitiating light source.

For the purposes of the present invention, the term “free radical polymerization” refers to any polymerization reaction that is initiated by any molecule comprising a free radical or radicals.

For the purposes of the present invention, the term “cationic polymerization” refers to any polymerization reaction that is initiated by any molecule comprising a cationic moiety or moieties.

For the purposes of the present invention, the term “anionic polymerization” refers to any polymerization reaction that is initiated by any molecule comprising an anionic moiety or moieties.

For the purpose of the present invention, the term “photoinitiator” refers to the conventional meaning of the term photoinitiator and also refers to sensitizers and dyes. In general, a photoinitiator causes the light initiated polymerization of a material, such as a photoactive oligomer or monomer, when the material containing the photoinitiator is exposed to light of a wavelength that activates the photoinitiator, i.e., a photoinitiating light source. The photoinitiator may refer to a combination of components, some of which individually are not light sensitive, yet in combination are capable of initiating polymerization of a polymerizable material (e.g., a photoactive oligomer or monomer), examples of which include a dye/amine, a sensitizer/iodonium salt, a dye/borate salt, etc.

For the purposes of the present invention, the term “photoinitiator component” refers to a single photoinitiator or a combination of two or more photoinitiators. For example, two or more photoinitiators may be used in the photoinitiator component to allow recording at two or more different wavelengths of light.

For the purposes of the present invention, the term “polymerizable component” refers to a mixture of one or more photoactive polymerizable materials, and possibly one or more additional polymerizable materials (i.e., monomers and/or oligomers) that are capable of forming a polymer.

For the purposes of the present invention, the term “photoactive polymerizable material” refers to a monomer, an oligomer and combinations thereof that polymerize by being exposed to a photoinitiating light source, e.g., recording light, either in the presence or absence of a photoinitiator that has been activated by the photoinitiating light source. In reference to the functional group that undergoes polymerization, the photoactive polymerizable material comprises at least one such functional group. It is also understood that there exist photoactive polymerizable materials that are also photoinitiators, such as N-methylmaleimide, derivatized acetophenones, etc. In such a case, it is understood that the photoactive monomer and/or oligomer may also be a photoinitiator.

For the purposes of the present invention, the term “photopolymer” refers to a polymer formed by one or more photoactive polymerizable materials, and possibly one or more additional monomers and/or oligomers.

For the purposes of the present invention, the term “thermoplastic” refers to the conventional meaning of thermoplastic, i.e., a composition, compound, material, medium, substance, etc., that exhibits the property of a material, such as a high polymer, that softens when exposed to heat and generally returns to its original condition when cooled to room temperature. Examples of thermoplastics include, but are not limited to: poly(methyl vinyl ether-alt-maleic anhydride), poly(vinyl acetate), poly(styrene), poly(ethylene), poly(propylene), cyclic olefin polymers, poly(ethylene oxide), linear nylons, linear polyesters, linear polycarbonates, linear polyurethanes, etc.

For the purposes of the present invention, the term “room temperature” refers to the commonly accepted meaning of room temperature, i.e., an ambient temperature of 20°-25° C.

For the purposes of the present invention, the term “thermoset” refers to the conventional meaning of thermoset, i.e., a composition, compound, material, medium, substance, etc., that is crosslinked such that it does not have a melting temperature. Examples of thermosets are crosslinked poly(urethanes), crosslinked poly(acrylates), crosslinked poly(styrene), etc.

For the purposes of the present invention, the term “X-Y plane” typically refers to the plane defined by the substrates or the holographic medium that encompasses the X and Y linear directions or dimensions. The X and Y linear directions or dimensions are typically referred to herein, respectively, as the dimensions known as length (i.e., the X-dimension) and width (i.e., the Y-dimension).

For the purposes of the present invention, the terms “Z-direction” and “Z-dimension” refer interchangeably to the linear dimension or direction perpendicular to the X—Y plane, and is typically referred to herein as the linear dimension known as thickness.

Description of Holographic Memory System Generally

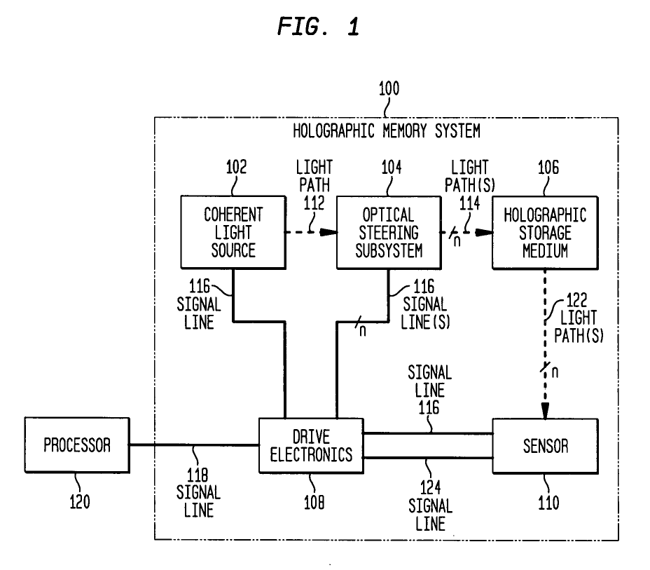

FIG. 1 is a block diagram of an exemplary holographic memory system in which embodiments of the present invention may be used. Although embodiments of the present invention may be described in the context of the exemplary holographic memory system shown in FIG. 1, the present invention may also be implemented in connection with any system now or later developed that implements holographics.

Holographic memory system 100 (“HMS 100” herein) receives along signal line 118 signals transmitted by an external processor 120 to read and write data to a photosensitive holographic storage medium 106. As shown in FIG. 1 processor 120 communicates with drive electronics 108 of HMS 100. Processor 120 transmits signals based on the desired mode of operation of HMS 100. For ease of description, the present invention will be described with reference to read and write operations of a holographic system. However, that the present invention may be applied to other operational modes of a holographic system, such as Pre-Cure, Post-Cure, Erase, Write Verify, or any other operational mode implemented now or in the future in an holographic system.

Using control and data information from processor 120, drive electronics 108 transmit signals along signal lines 116 to various components of HMS 100. One such component that may receive signals from drive electronics 108 is coherent light source 102. Coherent light source 102 may be any light source known or used in the art that produces a coherent light beam. In one embodiment, coherent light source 102 may be a laser.

The coherent light beam from coherent light source 102 is directed along light path 112 into an optical steering subsystem 104. Optical steering subsystem 104 directs one or more coherent light beams along one or more light paths 114 to holographic storage medium 106. In the write operational mode described further below at least two coherent light beams are transmitted along light paths 114 to create an interference pattern in holographic storage medium 106. The interference pattern induces alterations in storage medium 106 to form a hologram.

In the read operational mode, holographically-stored data is retrieved from holographic storage medium 106 by projecting a reconstruction or probe beam along light path 114 into storage medium 106. The hologram and the reconstruction beam interact to reconstruct the data beam which is transmitted along light path 122. The reconstructed data beam may be detected by a sensor 110. Sensor 110 may be any type of detector known or used in the art. In one embodiment, sensor 110 may be a camera. In another embodiment, sensor 110 may be a photodetector.

The light detected at sensor array 110 is converted to a signal and transmitted to drive electronics 108 via signal line 124. Processor 120 then receives the requested data or related information from drive electronics 108 via signal line 118.

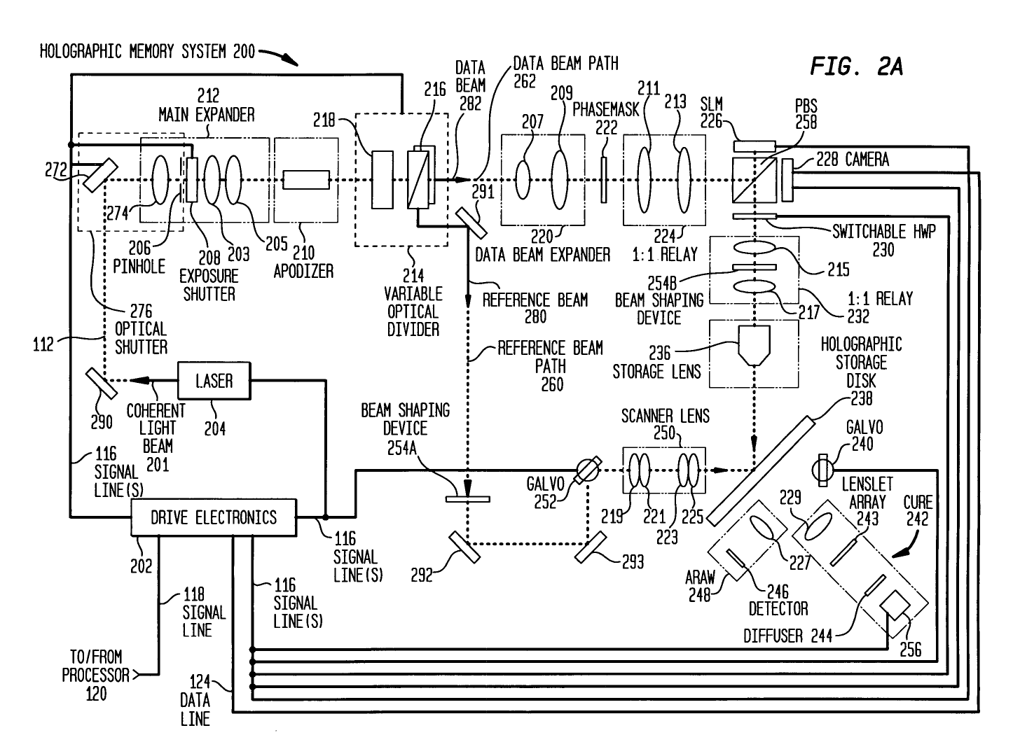

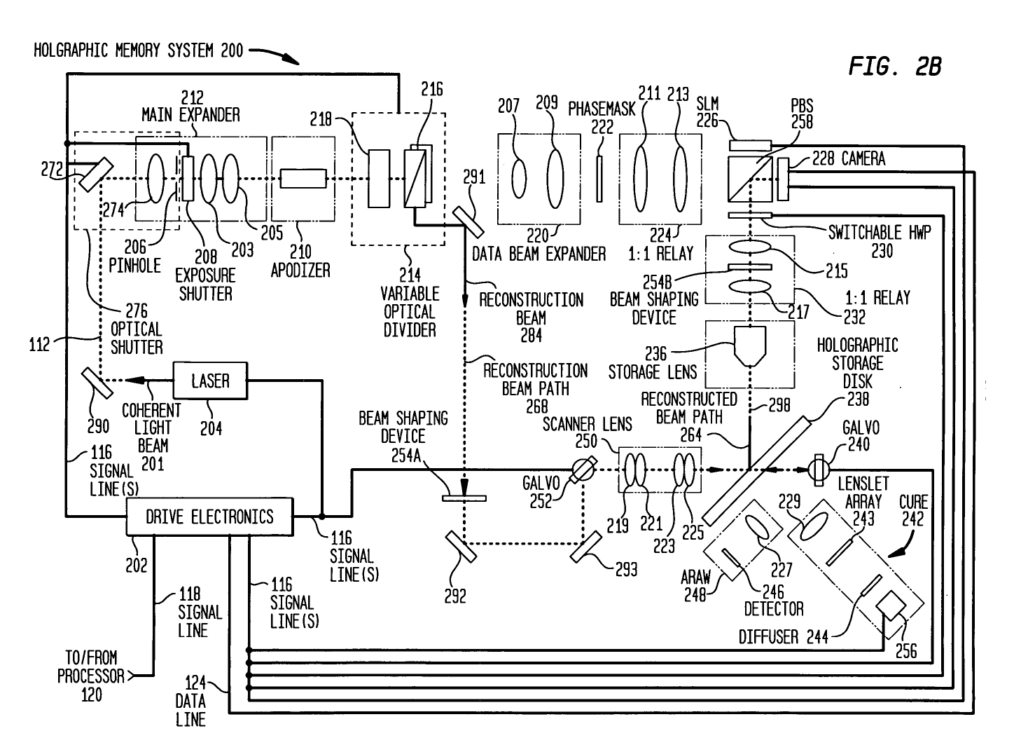

The components of an exemplary embodiment of HMS 100 are illustrated in more detail in FIGS. 2A and 2B, and is referred to generally as holographic memory system 200 (“HMS 200” herein). FIGS. 2A and 2B are similar schematic block diagrams of the components of one embodiment of HMS 200 illustrating the optical paths utilized during write and read operations, respectively.

Referring first to FIG. 2A, HMS 200 is shown in a record or write operation or mode (herein “write mode configuration”). Coherent light source 102 (see FIG. 1) is shown in FIG. 2A in the form of laser 204. Laser 204 receives via signal line 116 control signals from an embodiment of drive electronics 108 (FIG. 1), referred to in FIG. 2A as drive electronics 202. In the illustrated write mode configuration, such a control signal may cause laser 204 to generate a coherent light beam 201 which is directed along light path 112 (see FIG. 1).

Coherent light beam 201 from laser 204 is reflected by mirror 290 and may be directed through optical shutter 276. Optical shutter 276 comprises beam deviation assembly 272, focusing lens 274 and pinhole 206 that collectively shutter coherent light beam 201 from entering the remainder of optical steering subsystem 104. The details of the exemplary optical shutter 276 are described in more detail in the above-related U.S. App. No. [[INPH-0007-UT4], entitled “Improved Operational Mode Performance of a Holographic Data Storage (HDS) Drive System,” filed ______. Further, it should be noted that this is but one exemplary optical shutter and other embodiments may use a different type of optical shutter or an optical shutter need not be used.

Coherent light beam 201 passing through optical shutter 276 enters main expander assembly 212. Main expander assembly 212 includes lenses 203 and 205 to expand coherent light beam 201 to a fixed diameter and to spatially filter coherent light beam 201. Main Expander 212 also includes lens 274 and pinhole 206 to spatially filter the light beam. An exposure shutter 208 within main expander assembly 212 is an electromechanical device which may be used to control recording exposure times.

Upon exiting main expander assembly 212, the coherent light beam 201 may be directed through apodizer 210. Light emitted from a laser such as laser 204 may have a spatially varying distribution of light. Apodizer 210 converts this spatially varying intensity beam 201 from laser 204 into a more uniform beam with controlled edge profiles.

After passing through apodizer 210, coherent light beam 201 may enter variable optical divider 214. Variable optical divider 214 uses a dynamically-controlled polarization device 218 and at least one polarizing beam splitter (PBS) 216 to redirect coherent light beam 201 into one or more discrete light beams transmitted along two light paths 114 (see FIG. 1), referred to in FIG. 2A as light path 260 and light path 262. Variable optical divider 214 dynamically allocates power of coherent light beam 201 among these discrete light beams, indicated as 280 and 282. In the write operational mode shown in FIG. 2A, the discrete light beam directed along light path 260 is referred to as reference light beam 280 (also referred to herein as reference beam 280), while the discrete light beam directed along light path 262 is referred to as data light beam 282 (also referred to herein as data beam 282).

Upon exiting variable optical divider 214, reference beam 280 is reflected by mirror 291 and directed through a beam shaping device 254A. After passing through beam shaping device 254A, reference beam 280 is reflected by mirrors 292 and 293 towards galvo mirror 252. Galvo mirror 252 reflects reference beam 280 into scanner lens assembly 250. Scanner lens assembly 250 has lenses 219, 221, 223 and 225 to pivotally direct reference beam 280 at holographic storage medium 106, shown in FIG. 2A as holographic storage disk 238.

Referring again to variable optical divider 214, data light beam 282 exits variable optical divider 214 and passes through data beam expander lens assembly 220. Data beam expander 220 implements lenses 207 and 209 to magnify data beam 282 to a diameter suitable for illuminating Spatial Light Modulator (SLM) 226, located further along data beam path 262. Data beam 282 then passes through phasemask 222 to improve the uniformity of the Fourier transform intensity distribution. Data beam 282 illumination of phasemask 222 is then imaged onto SLM 226 via 1:1 relay 224 having lenses 211 and 213. PBS 258 directs data beam 282 onto SLM 226.

SLM 226 modulates data beam 282 to encode information into data beam 282. SLM 226 receives the encoding information from drive electronics 202 via a signal line 116. Modulated data beam 282 is reflected from SLM 226 and passes through PBS 258 to a switchable half-wave plate 230. Switchable half-wave plate 230 may be used to optionally rotate the polarization of data beam 282 by 90 degrees. A 1:1 relay 232 containing a beam-shaping device 254B and lenses 215 and 217 directs data beam 282 to storage lens 236 which produces a filtered Fourier transform of the SLM data inside holographic storage disk 238. At a particular point within holographic storage disk 238, reference beam 280 and data beam 282 create an interference pattern to record a hologram in holographic storage disk 238.

Referring next to the read mode configuration illustrated in FIG. 2B, laser 204 generates coherent light 201 in response to control signals received from drive electronics 202. As noted with regard to FIG. 2A, coherent light beam 201 is reflected by mirror 290 through optical shutter 276 that shutters coherent light beam 201 from entering the remainder of optical steering subsystem 104. Coherent light beam 201 thereafter enters main expander assembly 212 which expands and spatially filters the light beam, as described above with reference to FIG. 2A. Upon exiting main expander assembly 212, coherent light beam 201 is directed through apodizer 210 to convert the spatially varying intensity beam into a more uniform beam.

In the arrangement of FIG. 2B, when coherent light beam 201 enters variable optical divider 214, dynamically-controlled polarization device 218 and PBS 216 collectively redirect the coherent light into one discrete light beam 114, referred to as reconstruction beam 284. Reconstruction beam 284 travels along reconstruction beam path 268, which is the same path 260 traveled by reference beam 280 during the write mode of operation, as described with reference to FIG. 2A.

A desired portion of the power of coherent light beam 201 is allocated to this single discrete reconstruction beam 284 based on the selected polarization implemented in device 218. In certain embodiments, all of the power of coherent light beam 201 is allocated to reconstruction light beam 284 to maximize the speed at which data may be read from holographic storage disk 238.

Upon exiting variable optical divider 214, reconstruction beam 284 is reflected from mirror 291. Mirror 291 directs reconstruction beam 284 through beam shaping device 254A. After passing through beam shaping device 254A, reconstruction beam 284 is directed to scanner lens assembly 250 by mirrors 292 and 293, and galvo 252. Scanner lens assembly 250 pivots reconstruction beam 284 at a desired angle toward holographic storage disk 238.

During the read mode, reconstruction beam 284 may pass through holographic storage disk 238 and may be retro-reflected back through the medium by a second conjugator galvo 240. As shown in FIG. 2B, the data reconstructed on this second pass through storage disk 238 is directed along reconstructed data beam path 298 as reconstructed data beam 264.

Reconstructed data beam 264 passes through storage lens 236 and 1:1 relay 232 to switchable half wave plate 230. Switchable half wave plate 230 is controlled by drive electronics 202 so as to have a negligible polarization effect. Reconstructed data beam 264 then travels through switchable half wave plate 230 to PBS 258, all of which are described above with reference to FIG. 2A. PBS 258 reflects reconstructed data beam 264 to an embodiment of sensor 110 (see FIG. 1) in the form of a camera 228. The light detected by camera 228 is converted to a signal and transmitted to drive electronics 202 via signal line 124 (see FIG. 1). Processor 120 then receives the requested data and/or related information from drive electronics 202 via signal line 118 (see FIG. 1).

HMS 200 may further comprise an illuminative media cure subsystem 242. Media cure subsystem 242 is configured to provide a uniform curing beam with reduced coherence to storage disk 238 to pre-cure and/or post-cure a region of storage disk 238 following the writing process. Media cure subsystem 242 may comprise a laser 256 sequentially aligned with a diffuser 244, a lenslet array 243 and a lens 229. The light from laser 256 is processed by diffuser 244, lenslet array 243, and lens 229 to provide a uniform curing beam with reduced coherence prior to reaching storage disk 238. Embodiments of this media cure subsystem 242 are described greater detail below.

HMS 200 may additionally comprise an associative read after write (ARAW) subsystem 248. ARAW subsystem 248 is configured to partially verify a hologram soon after the hologram is written to holographic storage disk 238. ARAW subsystem may comprise a lens 227 and a detector 246. Holographic system 100 uses ARAW subsystem 248 by illuminating a written hologram with an all-white data page. When a hologram is illuminated by this all-white data page, ARAW subsystem 248 detects the reconstructed reference beam resulting from this all-white illumination. Specifically, detector 246 examines the reconstructed reference beam to verify that the hologram has been recorded correctly.

Description of Holographic Storage Medium

The formation of holograms using a holographic data storage system (e.g., HMS system 200 during the record/write mode shown in FIG. 2A) relies on a refractive index contrast (An) between light exposed and unexposed regions of a holographic storage medium, this contrast being at least partly due to polymerizable component (e.g., monomer/oligomer) diffusion to exposed regions. High index contrast may be desired because it provides improved diffraction efficiency when reading holographic data (e.g., during the read/reconstruct mode shown in FIG. 2B). One way to provide high index contrast is to use a photoactive polymerizable component (e.g., photoactive monomer/oligomer) having moieties (referred to as index-contrasting moieties) that are substantially absent from the support matrix, and that exhibit a refractive index substantially different from the index exhibited by the bulk of the support matrix. For example, high contrast may be obtained by using a support matrix that contains primarily aliphatic or saturated alicyclic moieties with a low concentration of heavy atoms and conjugated double bonds (providing low index) and a photoactive monomer/oligomer made up primarily of aromatic or similar high-index moieties.

The holographic medium may be formed in any suitable manner from a combination, blend, mixture, etc., which may comprise a support matrix, polymerizable component, photoinitiator component, etc. which may also be associated with or positioned between a support structure, such as a pair of (i.e., two) substrates (e.g., glass plates, plastic plates, etc.). The polymerizable component includes at least one photoactive polymerizable material that can form holograms when exposed to a photoinitiating light source. The photoactive polymerizable materials may include any monomer, oligomer, etc., that is capable of undergoing photoinitiated polymerization, with or without a photoinitiator. Suitable photoactive polymerizable materials may include those which polymerize by a free-radical reaction, e.g., molecules containing ethylenic unsaturation such as acrylates, methacrylates, acrylamides, methacrylamides, styrene, substituted styrenes, vinyl naphthalene, substituted vinyl naphthalenes, other vinyl derivatives, etc. It may also be possible to use cationically polymerizable systems; a few examples are vinyl ethers, alkenyl ethers, allene ethers, ketene acetals, epoxides, etc. Furthermore, anionic polymerizable systems may also suitable herein. It is also possible for a single photoactive polymerizable molecule to contain more than one polymerizable functional group.

For holographic media from which holographic data may be partially or completely erased, and which may optionally record new holographic data on the erased portions, a photoreactive material which reversibly forms the holographic data may be used. These photoreactive materials often create the holographic data when exposed to photoiniating light (e.g., recording light) having a first wavelength. To erase the recorded holographic data, the holographic data are often exposed to light of a second different wavelength that is non-photorecording or non-photocuring (i.e., is an erasing beam) to breakdown the reacted photoreactive material, and to desirably regenerate the photoreactive materials. These regenerated photoreactive materials may then be subjected to recording light of the first wavelength to generate new holographic data which is recorded by the holographic medium. Suitable photoreactive materials may include those that create a reversibly stable cyclic ring structure such as a cyclobutane ring via a 2+2 or 4+4 photodimerization. Some examples of photoreactive materials which may create reversibly stable cyclic ring structures include anthracenes, acenaphtylenes, vinyl pyridines, etc. The photoreactive materials may also include moieties located on the matrix support such as low index unsaturation (e.g., vinyl ether) to which acenaphthylene or other higher index group can photodimerize with. In such scenarios whereby a photoreactive material is used, the photoreactive material absorbs the recording light to form holographic gratings and then may absorb erasing light to erase the holographic gratings. Such materials may also be subjected to pre-curing and/or post-curing, as described below.

In addition to the at least one photoactive polymerizable material, the holographic medium may contain a photoinitiator which, upon exposure to relatively low levels of the recording light, chemically initiates the polymerization of the photoactive polymerizable material. From about 0.1 to about 20 vol. % photoinitiator may provide suitable results. The photoinitiators used may be sensitive to ultraviolet and visible radiation of from about 200 nm to about 800 nm. A variety of photoinitiators known to those skilled in the art and available commercially are suitable for use in the holographic medium, including free radical photoinitiators such as bis(η-5-2,4-cyclopentadien-1-yl)bis [2,6-difluoro-3-(1H-pyrrol-1-yl)phenyl]titanium, available commercially from Ciba as Irgacure 784™, 5,7-diiodo-3-butoxy-6-fluorone, commercially available from Spectra Group Limited as H-Nu 470, dye-hydrogen donor systems such as eosin, rose bengal, erythrosine, and methylene blue, and suitable hydrogen donors include tertiary amines such as n-methyl diethanol amine. In the case of cationically polymerizable components, a cationic photoinitiator may be used, such as a sulfonium salt or an iodonium salt which absorbs predominantly in the UV portion of the spectrum, which may be sensitized with a sensitizer or dye to allow use of the visible portion of the spectrum, or alternatively visible cationic photoinitiator such as (η₅-2,4-cyclopentadien-1-yl) (η₆-isopropylbenzene)-iron(II) hexafluorophosphate, available commercially from Ciba as Irgacure 261.

The holographic medium may also include additives such as plasticizers for altering the properties thereof including the melting point, flexibility, toughness, diffusibility of the monomers, ease of processibililty, etc. Examples of suitable plasticizers include dibutyl phthalate, poly(ethylene oxide) methyl ether, N,N-dimethylformamide, etc. Other types of additives that may be used in the holographic medium are inert diffusing agents having relatively high or low refractive indices. Inert diffusing agents typically diffuse away from the hologram being formed, and can be of high or low refractive index but are typically low. Thus, when, for example, a monomer of high refractive index is used, the inert diffusing agent may be of low refractive index, and ideally the inert diffusing agent diffuses to the nulls in an interference pattern. Overall, the contrast of the hologram may be increased. Other additives that may be used in the holographic medium include: pigments, fillers, nonphotoinitiating dyes, antioxidants, bleaching agents, mold releasing agents, antifoaming agents, infrared/microwave absorbers, surfactants, adhesion promoters, etc.

In addition to the photopolymeric systems described above, various other photopolymeric systems may be used in the holographic mediums. For example, suitable photopolymeric systems for use herein are also described in: U.S. Pat. No. 6,103,454 (Dhar et al.), issued Aug. 15, 2000; U.S. Pat. No. 6,482,551 (Dhar et al.), issued Nov. 19, 2002; U.S. Pat. No. 6,650,447 (Curtis et al.), issued Nov. 18, 2003, U.S. Pat. No. 6,743,552 (Setthachayanon et al.), issued Jun. 1, 2004; U.S. Pat. No. 6,765,061 (Dhar et al.), Jul. 20, 2004; U.S. Pat. No. 6,780,546 (Trentler et al.), Aug. 24, 2004; U.S. Patent Application No. 2003-0206320, published Nov. 6, 2003, (Cole et al), and U.S. Patent Application No. 2004-0027625, published Feb. 12, 2004, the entire contents and disclosures of which are herein incorporated by reference.

Description of Articles

Embodiments of articles comprising a holographic storage medium that may be used in the present invention may be of any thickness needed. For data storage applications, the article may be from about 0.2 to about 2 mm, more typically from about 1 to about 1.5 mm in thickness, and may be in the form of a film or sheet of holographic medium positioned between two substrates (e.g., sandwiched between the substrates) with at least one of the substrates having an antireflective coating and may be sealed against moisture and air. An article of the present invention may also be made optically flat via the appropriate processes, such as the process described in U.S. Pat. No. 5,932,045 (Campbell et al.), issued Aug. 3, 1999, the entire contents and disclosure of which is herein incorporated by reference.

Embodiments of an article may be of various sizes and shapes. The article may have a circular-shaped configuration (commonly referred to as a “disk,” “DVD,” “MO,” or “CD” format), or it may have other shapes, configurations, etc., including oval, square, rectangular, etc., for example, a square-shaped configuration commonly referred to as a “coupon” format. The size of the article in terms of width/length, diameter, etc., may be of any suitable dimension. For example, for CD formats, the article may have a diameter of from about 25 to about 140 mm, more typically from about 120 to about 130 mm.

Description of Pre-Curing, Post-Curing and Erasing and System

Embodiments of the present invention generally relate to subjecting a holographic storage medium at one or more points in the data storage cycle to illuminative treatment to: (1) enhance or optimize the recording of holographic data; (2) enhance or optimize the reading of recorded holographic data; or (3) erase recorded holographic data. These embodiments more specifically relate to: (a) processes for carrying out illuminative treatment (pre-curing, post-curing and erasing); (b) systems for carrying out illuminative treatment; and (c) various combinations of pre-curing, post-curing, erasing and recording of media.

Pre-Curing of Holographic Media

The present invention is based on the discovery that uncured holographic media may not record holograms in an optimal or even acceptable fashion. For example, the uncured holographic media may not initially record holograms at all or may record holograms that are not stable over time. Uncured holographic media have also been found to exhibit an inherent disadvantageous media response behavior. In other words, the uncured media is unable to record stable holograms, or records stable holograms only by using greatly increased exposure times (at relatively slower data transfer rates) or by using exposure times which vary significantly relative to exposure times of holograms recorded in the same or similar sequence in the same volume of the media.

These poorer or less than optimal recording properties may be due to a number of factors. One factor which may adversely affect the ability of uncured holographic media to record holographic data is the presence of polymerization inhibitors, especially oxygen, within the medium. For example, oxygen may be incorporated into the uncured holographic medium during processing, or may diffuse into the medium over time (e.g., within weeks or months) prior to use of the medium. When the uncured holographic medium is initially illuminated by a photoinitiating light source (e.g., recording light), the photoinitiator which is present may form multiple free radicals that catalyze or activate the reaction of the polymerizable components (e.g., monomers) that create the polymers generating or forming the holograms in the medium. Unfortunately, these free radicals may also preferentially react with any available oxygen. (and/or other inhibitors), rather than the polymerizable components. Until this reservoir of oxygen is essentially used up or depleted, the medium may not be able to effectively create the polymers necessary to generate or form the holograms. In other words, holograms initially may not form at all in the uncured holographic medium.

Another factor which may adversely affect the ability of uncured holographic media to record holographic data is the rate at which the photoinitiators, polymerizable and polymerized components, etc., diffuse through the holographic medium. Uncured holographic media may have an essentially inherent disadvantageous media response behavior because of the more rapid rate of polymer diffusion, as well as the changing rate of polymer diffusion. Initially, the physical size of the photoinitiators, polymerizable components, etc., relative to the support matrix of the medium, may be such that the initial polymer chains formed during exposure to the photoinitiating light (e.g., recording light) may rapidly diffuse through the medium. This initial rapid rate of diffusion may be so fast that the forming holograms do not become fixed or stable in the medium, but instead degrade or disappear because the polymer chains generating or forming these holograms simply diffuse into indistinct and unreadable structures. As the number of polymer chains increases with additional exposure to the recording light, the diffusion rate will eventually decrease and newly formed holograms will have far greater stability. Even so, the medium may still exhibit a disadvantageous media response behavior in recording holograms for some time because of the rapidly changing rate of polymer diffusion.

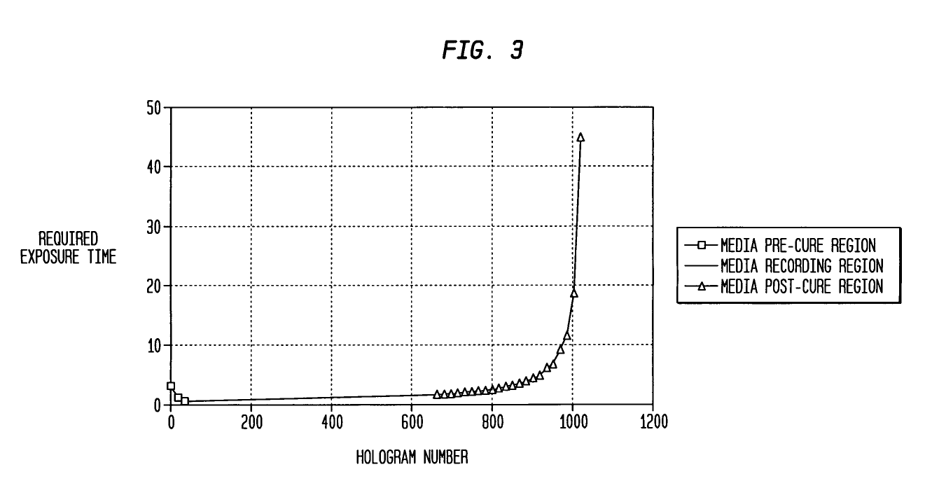

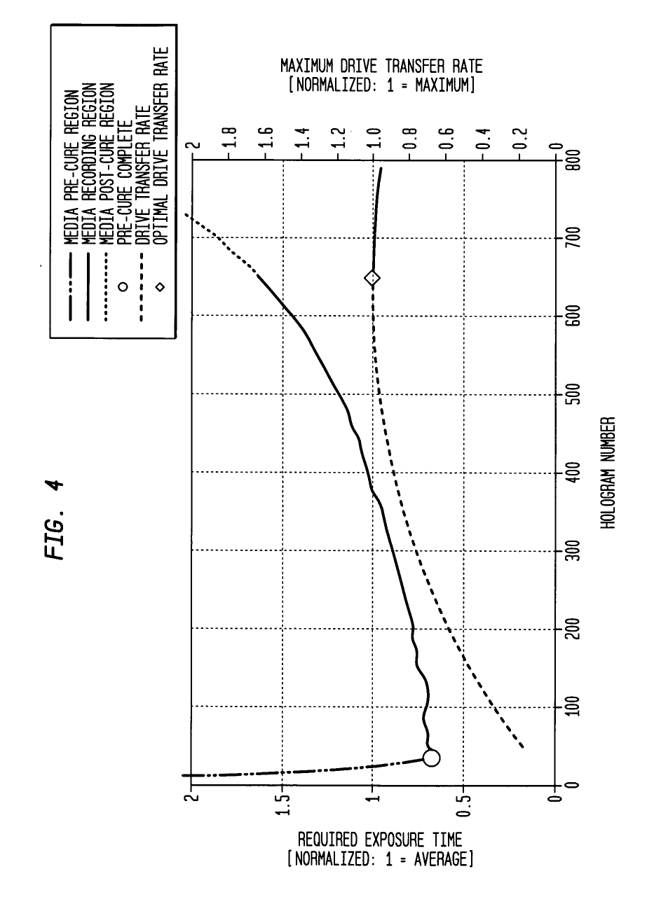

This disadvantageous media response behavior is illustrated in FIG. 3 and especially FIG. 4 by the left most portion or region of the respective media response curves. As shown in FIGS. 3 and 4, if the holographic medium is uncured, the first holograms which are recorded require relatively long and quickly changing exposure times as indicated by the height and relative steepness of the media response curve. As further particularly illustrated in FIG. 4, eventually this disadvantageous response behavior of the uncured holographic medium diminishes as the factors (e.g., polymerization inhibitors, rapidly changing diffusion rates, etc.) which cause this disadvantageous response behavior are reduced or eliminated as the cumulative input of energy into the uncured medium increases. After enough energy is inputted into the uncured medium, the media response curve may reach a region of the curve where the media response is relatively advantageous, as illustrated in FIG. 3 and particularly in FIG. 4 which show a relatively advantageous media response region of the media response curve (indicated as the Media Recording Region) where holograms having equal or nearly diffraction efficiencies may be recorded using the same or relatively similar exposure times to recording light. Ideally, in the Media Recording Region, the media response curves shown in FIG. 3 and especially FIG. 4 would be substantially flat or parallel to the x-axis. As a practical matter, the media response curve is generally never flat or parallel to x-axis, even in the Media Recording Region of the media response curve (see particularly FIG. 4) where the media response behavior is relatively advantageous.

While the transition from the disadvantageous media response region to the relatively advantageous media response region may be partially compensated for by the holographic data storage system (e.g., by initially using a significantly varying exposure schedule to record holograms), this may be difficult to achieve in practice due to the rapidly changing nature of the media response and, hence, the relatively high level of uncertainty regarding the required exposure times. The recording properties of uncured holographic media may be improved according to embodiments of the present invention by subjecting the uncured medium (or at least a portion of the uncured medium) prior to recording of holograms to illuminative curing to provide a pre-cured medium (or pre-cured portion of the medium) having an increased ability to stably record holographic data. In illuminative pre-curing according to embodiments of the present invention, this increased ability to stably record holographic data is achieved because of one or more of the following factors: (1) the reservoir of available oxygen (and/or other inhibitors) in the medium is consumed or depleted, and thus unavailable to preferentially react with free radicals formed by the photoinitiator; (2) large polymer chains are initially formed to minimize or prevent the rapid diffusion of polymer chains which are later created during holographic recording through the support matrix so that stable holograms may be formed; and (3) enough polymer chains are created to further reduce, diminish, retard, etc., the diffusion rate to one which is the same or similar to the average diffusion rate over most of the dynamic range of the medium. In addition, pre-curing may bias the medium into the relatively advantageous media response region of the media response curve (see Media Recording Region of FIGS. 3 and 4) such that holographic data may be recorded using the same or a similar amount of exposure to recording light, i.e., using the same or similar recording time, while still achieving the same or similar diffraction efficiencies. The ability to record holographic data in pre-cured portions of the medium having a relatively advantageous media response behavior may also lead to increased storage capacity and increased data transfer rates for the medium. This is particularly shown by the increasing slope of the data transfer rate curve in the Media Recording Region of FIG. 4.

In pre-curing of the holographic medium, the uncured medium (or portion thereof) may be subjected to illuminative curing by a curing beam having reduced coherence and a substantially uniform intensity distribution to increase, enhance, optimize, etc., the ability of the medium to stably record holographic data. Pre-curing of the medium may be carried out so that the pre-cured medium is biased into the relatively advantageous media response region of the media response curve (see, for example, Media Recording Region of FIG. 4). The particular conditions under which pre-curing is carried out may depend on a number of factors, including the composition of the holographic medium to be pre-cured, whether all or only a portion of the medium is to be pre-cured, the wavelength of the recording light used to record holograms after pre-curing, previous illuminative treatments, previous holographic recording, etc. Pre-curing may be carried out with a curing beam having a wavelength that is different from that of the recording light used to subsequently record holograms, but is often carried out with a curing beam having the same or similar wavelength as the recording light used to record the holograms to simplify the pre-curing process. Pre-curing may be carried out on the entire medium or only in a selected portion or portions of the medium. For example, in one embodiment, only a selected portion or portions of the medium in which holographic data is to be recorded during a recording session may be pre-cured.

The period of time (duration) that the uncured medium (or portion thereof) is subjected to illuminative curing with the curing beam may be according to a previously determined schedule based on prior pre-curing of holographic media having the same or a similar composition, using a curing beam having the same or a similar wavelength, etc. Alternatively, after subjecting the holographic medium (or portion thereof) to illuminative curing with the curing beam for a period of time believed to be sufficient to provide a suitable pre-cured medium (or portion thereof) having the desired ability to record stable holograms, the pre-cured medium may be evaluated or analyzed by recording one or more test holograms and then determining, from these recorded test holograms, whether the pre-cured medium has been biased into the relatively advantageous media response region based on the known media response curve of the medium. Alternatively, the progress of pre-curing may be determined by monitoring the luminescence of photoactive luminescent materials (e.g., photoactive fluorescent materials, photoactive phosphorescent materials, etc.) present in the medium or even by monitoring the intensity of the transmitted light (as a measure of the absorbance of the photoinitiators or photoreactive materials which may change in accordance with their concentration).

Post-Curing of Holographic Media

The present invention is also based on the discovery that holographic storage media, even after a significant amount of holographic data has been recorded to use up much of the dynamic range (e.g., in the range from about 70 to about 90% of the total dynamic range), may still retain residual sensitivity to subsequent exposure to light sources. This residual sensitivity may manifest itself by the recording of additional undesired holograms (e.g., noise holograms) by the holographic medium due to, for example, the self-interference of coherent light beams used for reading or reconstructing the holographic data, etc. These additional undesired holograms may degrade or impair the ability to read and reconstruct the recorded holographic data by, for example, obscuring the holographic data, significantly decreasing the signal to noise ratio (SNR), etc. It has been further discovered that, after a significant amount of holographic data has been recorded by the holographic medium (e.g., in the range of from about 70 to about 90% of the total dynamic range has been used), the medium may also tend to record holographic data more slowly and in an a more variable fashion, i.e., the media response curve of the medium is now in another disadvantageous media response region. See the region of the media response curve of FIG. 3 at around the point where 900 holograms have been recorded and where the required exposure time begins to increase dramatically, as reflected by the increasing steepness of the curve, as well as the data transfer rate curve in FIG. 4 where the data transfer rate begins to level off and decrease at the point where about 650 holograms have been recorded. In other words, the “practicable” dynamic range of the holographic medium may be essentially used up in recording holographic data.

One factor which may cause this residual sensitivity in holographic media is the presence of residual photoinitiator, residual photoactive polymerizable materials, residual photoreactive materials, etc., or any combination thereof. Residual photoinitiator may initiate or catalyze the formation of additional polymer chains that generate these additional undesired holograms. Residual photoactive polymerizable materials may provide the source materials to create the polymer chains that generate or form these additional undesired holograms. By contrast, the level of residual photoinitiator and/or photoactive polymerizable materials may be sufficiently low, especially after most of the dynamic range has been used up, to require the use of greatly increased exposure times to record additional desired holograms having equal or nearly equal diffraction efficiencies (i.e., a disadvantageous media response behavior). In other words, the recording of additional holographic data by the holographic medium is no longer as efficient (i.e., reflecting slower data transfer rates) as when the holographic data is recorded, for example, in the relatively advantageous media response region (see Recording Media Regions of FIGS. 3 and 4) of the media response curve.

This residual sensitivity of holographic media may be improved according to embodiments of the present invention by subjecting the holographic medium, after the recording of holographic data has reached a desired level in terms of the percentage of the total dynamic range used, to illuminative curing with a curing beam having reduced coherence and a substantially uniform intensity distribution to minimize, reduce, eliminate etc., this residual sensitivity to recording additional undesired holograms (e.g., noise holograms). Essentially, post-curing uses up the residual photoinitiator, residual photoactive polymerizable materials, or both, until the level these materials is minimized, reduced, diminished, etc., to the point that undesired holograms, such as noise holograms, are minimally formed or do not form in the holographic medium. By reducing or eliminating the formation of these additional undesired holograms through the use post-curing of the holographic medium, the recorded holographic data in the medium may be readily reconstructed and read by the holographic data storage system. In addition, post-curing may be carried out at or after the point where the “practicable” dynamic range of the holographic medium has been essentially used up, e.g., when from about 70 to about 90% of the total dynamic range of the medium has been used up.

The particular conditions under which post-curing is carried out may depend on a number of factors, including the composition of the holographic medium to be post-cured, the degree to which the total dynamic range of the medium has been used up, previous holographic recording, previous illuminative treatments, etc. Post-curing may be carried out at an appropriate wavelength, intensity, and for a period of time such that the residual sensitivity of the medium (e.g., as reflected by the level of residual photoinitiator, residual photoactive polymerizable components, or both) has been reduced, lowered, diminished, etc., so that the medium is unable to form additional undesired holograms (e.g., noise holograms), including those due to self-interference of a coherent light beam used for reconstructing and reading data, in sufficient quantities to adversely affect the recorded holographic data, e.g., decrease the SNR. Post-curing may be carried out with a curing beam having a wavelength that is different from that of the recording light used to record the holograms, but may also be carried out with a curing beam having the same or similar wavelength as the recording light used to record the holographic data to simplify the post-curing process. Post-curing may be carried out for a period of time (duration) previously determined to be suitable based on prior post-curing of holographic media having the same or a similar composition, using a curing beam having the same or a similar wavelength, etc. Alternatively, the rate of absorption of the curing beam by the holographic medium may be measured during the post-curing process itself. When the rate of change of absorption of the curing beam drops or falls below a certain predetermined value (e.g., as predetermined for holographic media having the same or similar properties, composition, etc.), thus indicating completion of post-curing, post-curing may then be terminated. Alternatively, the progress of post-curing may be determined by monitoring the luminescence of photoactive luminescent materials (e.g., photoactive fluorescent materials, photoactive phosphorescent materials, etc.) present in the medium.

After post-curing, substantially all of the dynamic range of the pre-cured portion is used up, e.g., from about 95 to 100% of the total dynamic range, more typically from about 99 to 100% of the total dynamic range. When the recorded portion of the holographic medium has been pre-cured, as described above, the pre-cured recorded portion may often be post-cured because pre-curing may sufficiently activate the pre-cured recorded portion of the medium so as to potentially increase the probability of recording undesired (e.g., noise) holograms, especially over the passage of time.

Erasing Holographic Medium

In some instances, it may be desirable to erase all or a portion of the holographic data recorded by the holographic medium. In addition, it may also be desirable to record (write) new holographic data to those portions of the holographic medium that have been erased. The ability to erase holographic data, as well as record new holographic data to the erased portion, generally requires that the components generating or forming the holographic data be reversible to regenerate the photoreactive materials. For example, exposure of these photoreactive materials to recording light of a particular first wavelength may cause the creation of the holographic data. Conversely, exposure of these recorded photoreactive materials a different second wavelength of light (i.e., the erasing beam) may cause these recorded photoreactive materials to breakdown and regenerate the photoreactive materials, thus erasing the holographic data. These regenerated photoreactive materials may again be exposed to recording light of the first wavelength to create new holographic gratings, and thus form new holographic data.

In erasing the recorded holographic data, at least the recorded portion of the holographic medium having holographic data may be subjected to illuminative erasing by an erasing beam to provide an erased portion wherein at least some of the recorded holographic data is erased. The erasing beam may be of any appropriate wavelength, intensity and/or duration to cause the gratings forming the recorded holographic data to breakdown to partially or completely erase the holographic data recorded on all or a portion of the holographic medium. The erasing beam often has a relatively short wavelength relative to the wavelength of the recording light, and is typically has a wavelength of about 350 nm or less, more typically about 290 nm or less (e.g., about 290 nm). Optionally, but desirably, the erasing beam causes regeneration of the photoreactive materials so that new holographic data may be recorded to the erased portions of the holographic medium. In an embodiment, the progress of erasing may be determined by monitoring the luminescence of photoactive luminescent materials (e.g., photoactive fluorescent materials, photoactive phosphorescent materials, etc.) or the photoreactive components present in the medium.

Systems for Curing and/or Erasing Media

Embodiments of a system according to the present invention for carrying out such pre-curing, post-curing or erasing of the holographic medium may comprise: (a) an illuminative treatment beam (i.e., a curing beam or an erasing beam); and (b) means for transmitting the illuminative treatment beam to cause illuminative treatment (i.e., illuminative curing or illuminative erasing) of: (1) an uncured portion of a holographic storage medium to provide pre-cured portions having increased ability to record holographic data; (2) a recorded portion of a holographic storage medium to provide a post-cured portion having reduced residual sensitivity; or (3) a recorded portion of a holographic storage medium having holographic data to provide an erased portion wherein at least some of the holographic data is erased.

A variety of sources of non-recording light may be used to generate the illuminative treatment beam (i.e., a curing beam or an erasing beam) in the embodiments of the illuminative treatment process and systems of the present invention. For example, the primary laser (e.g., laser 204 from HMS system 200) used to generate the data beam and/or reference beam may be used as the illuminative treatment beam in carrying out illuminative curing or illuminative erasing. Alternatively, one or more other, auxiliary lasers may be used as the source of the illuminative treatment beam. The use of lasers as the source of the illuminative treatment beam may provide high power transmission and coupling efficiency, and have lower numerical aperture (and hence size) requirements because of the ability to control beam divergence more closely. The laser used to provide the illuminative treatment beam may generate a single wavelength or may be adjustable to generate different wavelengths of light. For example, if laser 204 from HMS system 200 were used as the source of the erasing beam, laser 204 may be adjustable to provide a first wavelength of light for recording holographic data, and a second different wavelength of light for generating the erasing beam.

Light emitting diodes (LEDs) may also be used as the source of the illuminative treatment beam. A single LED may be used as the illuminative treatment beam, or an array of LEDs may be used to achieve higher peak power levels in the illuminative treatment beam. Use of an LED(s) may also provide a relatively reduced coherence illuminative treatment beam which does not interfere with itself and thus produce interference fringes or other undesired diffraction effects that may degrade the quality of the illuminative treatment that is carried out on the holographic medium. The LED(s) used to provide the illuminative treatment beam may generate a single wavelength or may be adjustable to generate different wavelengths of light.

The illuminative treatment beam may be dithered in angle or position to enhance the uniformity of the effect of the illuminative treatment beam on the holographic medium. Because of the coherence of laser beams, embodiments of illuminative treatment systems using such illuminative treatment beams may be designed in such a way as to control, minimize or eliminate coherent noise (fringing, diffraction, etc.) that may cause undesirable effects (e.g., “striations,” etc.) in the holographic medium due to non-uniform illuminative treatment and may ultimately be a source of noise holograms, SNR degradation, etc. Coherence of the illuminative treatment beam may be reduced, for example, to less than the thickness of the holographic medium. Coherence reduction may be achieved by including a diffuser in the illuminative treatment system pathway to thus cause the illuminative treatment beam to have different optical phases across the hologram and reduce the chance of self-interference. Motion may be imparted to the diffuser such as oscillation, vibration, etc., for the purpose of reducing temporal coherence by blurring out over time any localized intensity variations caused by self-interference with the illuminative treatment beam. Use of a diffuser may have a further advantage of creating a more uniform intensity distribution or profile to during illuminative treatment. Another approach for achieving coherence reduction that may provide a more compact system design is to use integrating rods for the transmitting the illuminative treatment beam, wherein the multiple refractions and/or reflections of the illuminative treatment beam within the rods may serve to diffuse the beam. Yet another approach for achieving coherence reduction is to modulate the electrical current to the source of the illuminative treatment beam (e.g., laser) with a high frequency (e.g., hundreds of megaHertz) signal so as to cause the temporal mode structure of the illuminative treatment beam to be multimode (i.e., multi-wavelength), thus reducing the coherence of the beam and the ability to self-interfere. Yet another approach for achieving coherence reduction is to use a rapidly scanning reference beam as the illuminative treatment beam.

The diffusion angle should be large enough to achieve coherence reduction in the illuminative treatment beam, but also small enough to enable as much of the light as possible in the beam to pass through the illuminative treatment system. To further increase the uniformity of the illuminative treatment process, the diffuser may be moved during illuminative treatment by translation, vibration, rotation, etc., which may smooth out any intensity variations at the holographic medium plane caused by the diffuser itself, or by self-interference of the illuminative treatment beam. To achieve adequate blurring by this technique, the motion imparted to the diffuser should be sufficient to move the diffuser many of its own correlation lengths during illuminative treatment. Suitable linear and/or rotational motion may be imparted to the diffuser, for example, by linear or rotary stages driven, for example, by stepper (discrete) or DC-servo motors (continuous). Such a diffuser design should also not substantially blur the edges of the treated area, nor cause a significant loss of transmission of the illuminative treatment beam through the illuminative treatment system. For example, this may be achieved by using a diffuser that has a small diffusion angle of a few degrees or less, and/or by placing the diffuser in a location that is not in an image plane of the holographic medium.

The illuminative treatment beam may have the same wavelength as that used in recording the holographic data, or the illuminative treatment beam may have a different wavelength(s) chosen to enhance or optimize a specific characteristic of the treated holographic medium (e.g., to provide peak or maximum absorption of the beam by photoactive materials present in the medium), or to perform a specific illuminative treatment process. For example, an illuminative treatment beam having a shorter wavelength may increase absorption and thus increase the speed of illuminative treatment, or may be used to perform a different illuminative treatment process, e.g., erasing holographic data from the holographic medium. If auxiliary laser beams are used as the source of the illuminative treatment beam, the illuminative treatment beam may be transmitted through the existing components (e.g., reference beam path 260 of HMS system 200) of the holographic data storage system to cause illuminative treatment of the holographic medium. Alternatively, a beam splitter may be used to inject a separate auxiliary beam as the illuminative treatment beam, of the same or a different wavelength, at some appropriate point into the reference beam path so that the illuminative treatment beam is transmitted to cause illuminative treatment of the holographic medium. In some embodiments, the auxiliary beam(s) may be injected into the data beam path (e.g., path 262 of HMS system 200) instead of, or in addition to, the reference beam path for transmission as an illuminative treatment beam to cause illuminative treatment of the holographic medium. The source of illuminative treatment beam may also be provided by a separate beam path using a different set of transmission components (e.g., a different optical path) to carry out illuminative treatment of the holographic medium. The path for transmitting the illuminative treatment beam may cause illuminative treatment to be carried out at the same location in the system where holographic data is recorded to and/or read from the holographic medium, or at a different location in the system where only illuminative treatment of the holographic medium is carried out.

A fiber optic or fiber optic bundle may be used to transmit the illuminative treatment beam from a laser, LED, or an array of lasers or LEDs, to other components for transmitting the illuminative treatment beam to cause illuminative treatment of the holographic medium. A single- or multi-element lens may be used to collect some of the light from a single laser or LED to provide a collected illuminative treatment beam, and then to transmit that collected illuminative treatment beam towards the holographic medium to be subjected to illuminative treatment. Because light from a laser, LED or array thereof may diverge, a multi-element lens may also be used to increase the collection efficiency of the illuminative treatment beam used in the illuminative treatment system. A matched lenslet array may also be used to approximately collimate the light from the individual lasers or LEDs, or arrays thereof to provide a collimated illuminative treatment beam and to transmit the collimated illuminative treatment beam towards the holographic medium to be subjected to illuminative treatment. Alternatively, single or multiple lasers or LEDs may be coupled to a fiber optic or fiber optic bundle to enable optical power transmission of the illuminative treatment beam to a remote point or location for carrying out illuminative treatment of the holographic medium.

The illuminative treatment beam may be transmitted to provide a substantially uniform intensity distribution during illuminative treatment. The illuminative treatment beam may also be formed or otherwise shaped to cause illuminative treatment of only a selected portion or portions of the holographic medium, or all of the holographic medium. Such shaping of the illuminative treatment beam may be desirably carried out with minimal power losses and using as little space as possible or practicable in the system. Shaping of the illuminative treatment beam may be achieved by using the combination of a lenslet array and a transform (i.e., focusing) lens. The lenslet or lenslets may have physical apertures which, when transformed by the lens, form or create the shape of the desired illumination area on the holographic medium, and may be any of desired configuration, including square-shaped, rectangular-shaped, hexagonal-shaped, circular-shaped, oval- or elliptical-shaped, etc. In addition, the illuminated area provided by the lenslet or lenslet array may be altered by simply changing individual lenslets or multiple lenslets in the array depending upon the illuminated area desired. A transform lens may be used in this combination to effectively collimate each separate beam from each lenslet, and thus cause some or all of the lenslet beams to overlap in the area or portion of the holographic medium being subjected to illuminative treatment. The transform lens may also break up the wavefront of the illuminative treatment beam so as to reduce the spatial coherence of the beam, thus helping to reduce, minimize or eliminate coherent noise effects in the illuminative treatment beam. Shaping of the illuminative treatment beam may also be achieved by using a physical aperture, imaging an illuminated aperture; imaging a shaped and/or apertured end of an optic fiber, etc.

The illuminative treatment beam may also be transmitted, for example, by a fiber optic bundle, light pipe, etc., or combined with an appropriate physical aperture to form a specific illumination pattern, such as one that matches the “footprint” of the holographic recording area on the holographic medium. The transmitted illuminative treatment beam may also be coupled to an additional lens assembly, which images the output end of a fiber optic bundle, a physical aperture or a shaped aperture in a lens and/or fiber optic assembly, to a point, area, portion, etc., on the holographic medium where illuminative treatment is to be carried out so as to maximize the illuminative treatment efficiency.

The speed of the illuminative treatment may depend on the amount of light power absorbed by the holographic medium. To increase the rate or speed of illuminative treatment, the holographic medium may be subjected to multi-pass illuminative curing or erasing. Some portion of the illuminative treatment beam often passes through and is not absorbed by the holographic medium. In multi-pass illuminative curing or erasing, all or a portion of the unabsorbed illuminative treatment beam that passes through may be reflected back through the holographic medium to effect additional illuminative treatment (i.e., pre-curing, post-curing or erasing). The unabsorbed illuminative treatment beam that is transmitted to one side and passes through the holographic medium may be reflected back by any suitable optical device or devices positioned on the opposite side of the medium, for example, a mirror, (e.g., a flat mirror or parabolic mirror), a combination of one or more lenses and a mirror, etc., to achieve multi-pass illuminative curing or erasing. The reflected illuminative treatment beam may also be manipulated, controlled, influenced, etc., to improve, control, correct, etc., the treatment beam's direction, focus, illuminative profile, etc., by using one or more optical devices, for example parabolic mirrors, lenses, combination of one or more lenses and mirror, etc. Such multi-pass illuminative curing or erasing may significantly reduce the time required to achieve the desired degree of illuminative curing or erasing of the holographic medium.

The illuminative treatment beam may be transmitted to treat all of or the entire holographic medium, or only a selected sector or portion thereof which may have an annular or ring shape, a wedge or pie shape, etc. Where the size of the illuminative treatment beam is such that the beam does not cover all of a selected portion of the holographic medium to be treated, the holographic medium may be moved relative to the beam while the selected portion of the medium to be treated is simultaneously and continuously illuminated with the beam. In one embodiment, movement of the medium is carried out by substantially linear translation of the medium. In an alternative embodiment, movement of the medium alternates between: (1) a substantially linear translation in a first direction; and (2) a substantially linear translation in a second direction which is transverse (e.g., substantially orthogonal) to the first direction. In another embodiment, movement of the medium is carried out by continuous, unidirectional rotation of the medium. In another embodiment, movement of the medium is carried out by alternating between: (1) continuous, unidirectional rotation of the medium; and (2) a substantially linear translation of the medium. In another embodiment, the selected portion of the medium is incrementally illuminated with illuminative treatment beam at discrete locations to provide a treated portion having contiguous or nearly contiguous tiled geometry.

An embodiment of an illuminative treatment system of the present invention which may, for example, be used as subsystem 242 in HMS 200 of FIGS. 2A and 2B is shown in FIG. 3 and is indicated generally as 300. Illuminative treatment system 300 includes a light source, indicated generally as 304, which may be a laser, LED or an array thereof, to generate an illuminative treatment beam, indicated generally as 308. As shown in FIG. 3, source 304 may be a separate light source for generating illuminative treatment beam 308, or alternatively source 304 may be the light source used to record and read holographic data, such as, for example, laser 204 from HMS system 200. The illuminative treatment beam 308 may be transmitted from source 304 through a collimating lens, indicated as 316. The collimated treatment beam 324 from lens 316 may, in some embodiments of system 300, be transmitted to a diffuser, indicated as 332, to reduce the coherence (e.g., spatial coherence) of beam 324. As indicated by double headed arrow 340, diffuser 332 may be moved (e.g., oscillated) to reduce any residual intensity variations (e.g., temporal coherence) in the resulting diffused treatment beam 324. The diffused treatment beam 348 may be transmitted from diffuser 332 to a lenslet array, indicated as 356, to form diffused beam 348 into a shaped treatment beam, indicated as 364. Shaped treatment beam 364 may be transmitted to a storage lens (e.g., a Fourier Transform lens), indicated as 372, and then focused as a converging generally cone-shaped focused treatment beam 380 having a treatment beam profile, indicated as 388, onto a holographic storage disk 238. As further shown in FIG. 3, system 300 may be provided with a reflecting element (e.g., mirror), indicated as 392, for reflecting back at least a portion of the unabsorbed beam 380, indicated generally as 396, to effect additional treatment of storage disk 238.

Illuminative treatment system 300 may be included as part of a holographic data storage system (e.g., as subsystem 242 of HMS system 200 of FIGS. 2A and 2B) that records/writes holographic data to and/or reads/reconstructs holographic data from the holographic medium. For example, illuminative treatment system 300 may be selectively used to pre-cure, post-cure and/or erase the holographic medium at appropriate points in the storage cycle of the holographic data storage system. Alternatively, illuminative treatment system 300 may be separate and apart from such a holographic data storage system, and may be used to pre-cure, post-cure and/or erase holographic medium or media: (a) obtained from such a holographic data storage system; and/or (b) provided for use in such a holographic data storage system. Illuminative treatment system 300 may be used to pre-cure, post-cure or erase holographic medium individually, or may be used to pre-cure, post-cure or erase a plurality of holographic medium at the same time, or approximately the same time.

Combinations of Pre-Curing, Post-Curing, Erasing and Recording of Media

In embodiments according to the present invention, pre-curing, post-curing and erasing may be used separately in illuminative treatment of the holographic medium. In embodiments according to the present invention, pre-curing, post-cure and erase of the may also be used in combination in illuminative treatment of the holographic medium, as well as in combination with recording of holographic data to the holographic medium. In an embodiment, pre-curing of an uncured portion of the medium, or post-curing of a recorded portion of the medium, may be concurrently carried out while holographic data is recorded to a different portion of the medium. In another embodiment, post-curing may be carried out on a holographic medium having a recorded portion and a pre-cured unrecorded portion, for example, to close out or finish the entire medium, or to close out or finish a selected sector or portion of the medium, so that no additional holographic data may be recorded (e.g., unavoidably or by accident) in the finished medium, or in the finished sector or portion of the medium. In another embodiment, pre-curing may be carried out, followed by recording of holographic data to the pre-cured portion to provide a recorded portion, followed by post-curing of the recorded portion to provide a post-cured recorded portion. In another embodiment, erasing of holographic data from the recorded portion of the medium may be carried out while concurrently carrying out one or more of the following steps: (1) recording holographic data in a different portion of the holographic medium; (2) pre-curing a different uncured portion of the holographic medium to provide a pre-cured portion; or (3) post-curing a different recorded portion of the holographic medium to provide a post-cured portion. In another embodiment, a recorded portion of the holographic medium may be post-cured to provide a post-cured recorded portion, followed by erasing of the post-cured recorded portion to provide an erased portion wherein at least some of the recorded holographic data is erased, optionally with recording of new holographic data to the erased portion of the medium, and optionally with pre-curing of an uncured portion of the holographic medium prior to recording holographic data to the provide the recorded portion.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

What is claimed is:

1. A process comprising the following steps of:
(a) providing a holographic storage medium having a recorded portion; and
(b) subjecting the recorded portion to illuminative post-curing with a curing beam having reduced coherence and a substantially uniform intensity distribution to provide a post-cured portion having reduced residual sensitivity.

2. The process of claim 1, wherein step (b) is carried out with a curing beam having the same wavelength of light as that of recording light used to record holographic data to the recorded portion.

3. The process of claim 1, wherein step (b) is carried out with a curing beam having a different wavelength of light from that of recording light used to record holographic data to the recorded portion.

4. The process of claim 3, wherein step (b) is carried out with a curing beam having a wavelength providing maximum absorption by photoactive materials present in the holographic medium.

5. The process of claim 1, wherein step (b) is carried out for a predetermined period.

6. The process of claim 1, wherein step (b) is carried out by multi-pass curing of the recorded portion.

7. The process of claim 1, wherein step (b) is carried out so as to post-cure only a selected recorded portion of the holographic medium.

8. The process of claim 7, wherein step (b) is carried out by moving the holographic medium relative to the curing beam while simultaneously and continuously illuminating the selected recorded portion with the curing beam.

9. The process of claim 8, wherein movement of the holographic medium carried out in step (b) comprises a substantially linear translation of the holographic medium.

10. The process of claim 8, wherein movement of the holographic medium carried out in step (b) alternates between: (1) a substantially linear translation of the holographic medium in a first direction; and (2) a substantially linear translation of the holographic medium in a second direction which is transverse to the first direction.

11. The process of claim 10, wherein the first and second directions of the holographic medium are substantially orthogonal.

12. The process of claim 9, wherein movement of the holographic medium carried out in step (b) comprises a continuous, unidirectional rotation of the holographic medium.

13. The process of claim 8, wherein the holographic medium motion carried out in step (b) alternates between: (1) continuous, unidirectional rotation of the holographic medium; and (2) a substantially linear translation of the holographic medium.

14. The process of claim 8, wherein the holographic medium motion carried out in step (b) is carried out by simultaneously performing (1) continuous, unidirectional rotation of the holographic medium; and (2) a substantially linear translation of the holographic medium

15. The process of claim 1, wherein step (a) comprises providing a holographic storage medium comprising photoactive luminescent materials and wherein the degree of post-curing during step (b) is determined by monitoring the luminescence of the luminescent materials.

16. The process of claim 15, wherein step (a) comprises providing a holographic storage medium comprising photoactive fluorescent materials.

17. The process of claim 15, wherein step (a) comprises providing a holographic storage medium comprising photoactive phosphorescent materials.

18. The process of claim 1, wherein the degree of post-curing during step (b) is determined by monitoring the transmittance of the curing beam.

19. The process of claim 1, wherein step (a) is carried out by providing a holographic medium comprising residual free radical photoinitiator and a polymerizable component comprising residual photoactive polymerizable material that is caused to be polymerized by a free radical photoinitiator.

20. The process of claim 1, wherein step (a) is carried out by providing a holographic medium having a recorded portion and a pre-cured unrecorded portion, and wherein step (b) is carried out on the recorded portion and the pre-cured unrecorded portion.

21. The process of claim 1, wherein step (b) is carried out with a curing beam having a wavelength providing maximum absorption by photoactive materials present in the holographic medium

22. The process of claim 1, wherein step (b) is carried out while concurrently carrying out the following additional step of recording holographic data in a different portion of the holographic medium.

23. A system comprising:
a curing beam;
means for reducing coherence of the curing beam to provide a curing beam having reduced coherence; and
means for transmitting the reduced coherence curing beam with a substantially uniform intensity distribution to cause illuminative post-curing of a recorded portion of a holographic storage medium to provide a post-cured portion having reduced residual sensitivity.

24. The system of claim 23, which is part of a holographic data storage system.

25. The system of claim 24, wherein the curing beam is generated by a laser from the holographic data storage system.

26. The system of claim 25, wherein the laser is adjustable to provide a first wavelength of light for recording holographic data, and a second different wavelength of light for generating the curing beam.

27. The system of claim 23, which further comprises a separate non-recording light source to generate the curing beam.

28. The system of claim 27, wherein the separate non-recording light source is a laser.

29. The system of claim 27, wherein the separate non-recording light source is a light emitting diode.

30. The system of claim 27, which is separate from a holographic data storage system.

31. The system of claim 27, which is part of a holographic data storage system.

32. The system of claim 23, wherein the coherence reducing means comprises a diffuser.

33. The system of claim 32, wherein the coherence reducing means comprises means for imparting motion to the diffuser.

34. The system of claim 23, wherein the coherence reducing means comprises integrating rods.

35. The system of claim 23, wherein the curing beam is generated by a laser and wherein the coherence reducing means comprises means for modulating the electrical current to the laser generating the curing beam.

36. The system of claim 23, wherein the transmitting means comprises means for shaping the curing beam so as to cause illuminative post-curing of a selected recorded portion of the holographic medium.

37. The system of claim 36, wherein the shaping means shapes the curing beam to a predetermined shape.

38. The system of claim 37, wherein the shaping means comprises a combination of a lenslet array and a transform lens.

39. The system of claim 23, wherein the transmitting means comprises at the least a portion of an optical path of a holographic data storage system.

40. The system of claim 39, wherein the optical path comprises a reference beam optical path.

41. The system of claim 39, wherein the optical path comprises the data beam optical path.

42. The system of claim 23, wherein the transmitting means includes means for reflecting at least a portion of unabsorbed curing beam through the holographic medium to cause multi-pass pre-curing of the uncured portion.

43. The system of claim 42, wherein the curing beam is transmitted to one side of the holographic medium and wherein the reflecting means is positioned on the opposite of the holographic medium.

44. The system of claim 43, wherein the reflecting means comprises a mirror.

45. The system of claim 44, wherein the reflecting means comprises a parabolic mirror or the combination of one or more lenses and a mirror.

46. A process comprising the following steps:
(a) providing a holographic storage medium having an uncured portion;
(b) subjecting the uncured portion to illuminative pre-curing with a curing beam having reduced coherence and a substantially uniform intensity distribution to provide a pre-cured portion having increased ability to stably record holographic data;
(c) recording holographic data in the pre-cured portion to provide a recorded portion having holographic data; and
(d) subjecting the recorded portion to illuminative post-curing with a curing beam having reduced coherence and a substantially uniform intensity distribution to provide a post-cured recorded portion having reduced residual sensitivity.

47. The process of claim 46, wherein steps (b) and (d) are each carried out with a pre-curing beam and post-curing beam having a wavelength providing maximum absorption by photoactive materials present in the holographic medium.

48. The process of claim 46, wherein steps (b) and (d) are each carried out for a predetermined period.

49. The process of claim 46, wherein step (a) is carried out by providing a holographic medium comprising a free radical photoinitiator and a polymerizable component comprising a photoactive polymerizable material that is caused to be polymerized by a free radical photoinitiator.

50. The process of claim 46, wherein steps (b) and (d) are carried out by multi-pass curing.

51. The process of claim 46, wherein step (a) comprises providing a holographic storage medium comprising photoactive luminescent materials and wherein the degree of pre-curing and post-curing during each of steps (b) and (d) is determined by monitoring the luminescence of the luminescent materials.

52. The process of claim 46, wherein the degree of post-curing during step (b) is determined by monitoring the transmittance of the curing beam.

53. A system comprising:
a curing beam;
means for reducing coherence of the curing beam to provide a curing beam having reduced coherence; and
means for transmitting the reduced coherence curing beam with a substantially uniform intensity distribution to cause, in sequence: (1) illuminative pre-curing of an uncured unrecorded portion of a holographic storage medium to provide a pre-cured portion having increased ability to stably record holographic data; and (2) illuminative post-curing of the pre-cured portion having recorded holographic data to provide a post-cured recorded portion having reduced residual sensitivity.

54. The system of claim 53, which is part of a holographic data storage system.

54. The system of claim 54, wherein the curing beam is generated by a laser from the holographic data storage system.

56. The system of claim 55, wherein the laser is adjustable to provide a first wavelength of light for recording holographic data, and a second different wavelength of light for generating the curing beam.

57. The system of claim 53, which further comprises a separate non-recording light source to generate the curing beam.

58. The system of claim 57, wherein the separate non-recording light source is a laser.

59. The system of claim 57, wherein the separate non-recording light source is a light emitting diode.

60. The system of claim 53, wherein the coherence reducing means comprises a diffuser.

61. The system of claim 60, wherein the coherence reducing means comprises means for imparting motion to the diffuser.

63. The system of claim 53, wherein the curing beam is generated by a laser and wherein the coherence reducing means comprises means for modulating the electrical current to the laser generating the curing beam.

64. The system of claim 53, wherein the transmitting means comprises at the least a portion of an optical path of a holographic data storage system.

65. The system of claim 64, wherein the optical path comprises a reference beam optical path.

66. The system of claim 64, wherein the optical path comprises the data beam optical path.

67. The system of claim 53, wherein the transmitting means includes means for reflecting at least a portion of unabsorbed curing beam through the holographic medium to cause multi-pass pre-curing or post-curing.

68. The system of claim 67, wherein the curing beam is transmitted to one side of the holographic medium and wherein the reflecting means is positioned on the opposite of the holographic medium.

69. The system of claim 68, wherein the reflecting means comprises a mirror.

70. The system of claim 69, wherein the reflecting means comprises a parabolic mirror or the combination of one or more lenses and a mirror.
